(19) United States
(12) Patent Application Publication
(10) Pub. No.: US 2010/0095114 A1
(43) Pub. Date: Apr. 15, 2010

(54) METHOD AND SYSTEM FOR ENCRYPTING AND DECRYPTING DATA STREAMS

(76) Inventors: Richard Greene, Austin, TX (US); Igor Komir, Austin, TX (US); Ronnin Yee, Round Rock, TX (US)

Correspondence Address: KENYON & KENYON LLP, 1500 K STREET, NW, WASHINGTON, DC, 20005-1257, US

(21) Appl. No.: 12/249,305

(22) Filed: Oct. 10, 2008

(51) Int. Cl. H04L 9/18; H04L 29/06

(52) U.S. Cl. 713/160; 380/42

(57) ABSTRACT

A method of encrypting a data stream includes receiving the data stream, and for each data packet in the data stream, forming an encrypted packet by encrypting a header portion of the data packet while leaving a body portion of the data packet unencrypted. The method also includes assembling an encrypted data stream comprising all the encrypted packets, and outputting the encrypted data stream.

### BACKGROUND INFORMATION

Data encryption is an important aspect of electronic communications. When data is transmitted from one location to another, it may be desirable to encrypt the data so that only an authorized recipient can read it. Data encryption has traditionally been applied to written communications between electronic devices, e.g., email and text messages. However, the introduction of computer graphics has enabled the encrypting of images in addition to text. Image encryption renders all or a portion of an image unreadable. That is, neither a human observer nor an electronic image reader would be able to discern any meaningful information from an encrypted image without first decrypting the image.

One problem with current image encryption techniques is that, depending on a method by which an image is encoded, it may be difficult or impossible to encrypt in a satisfactory manner. Newer image formats such as JPEG2000 are in many ways technically superior to older formats. For example, compared to the original JPEG standard, JPEG2000 offers improved compression performance, e.g., fewer artifacts, resulting in a higher fidelity to the original image, and enhanced bit rate control. However, owing to added complexity, encryption of images encoded in JPEG2000 is often more computationally expensive, e.g., drawing processing power or taking up system resources such as bus bandwidth, than encrypting images encoded in the original JPEG standard. Decryption of encrypted images is corresponding expensive. In some situations, the added expense may be prohibitive. For example, when image decoding is required to take place in substantially real time, e.g., Internet streaming, television, video surveillance and other audiovisual applications, it may not be possible to encrypt and/or decrypt quickly enough to meet bandwidth requirements. Another situation is when there is a large volume of image data to be encrypted, e.g., large image files, multi-image media such as video clips, slideshows, movies, digital albums, etc. In the latter situation, although there may not be an immediate need for a final product, e.g., a fully encrypted image or a fully decrypted image, overall time constraints may be a limiting factor. Further, costly encryption and decryption may draw resources away from other applications running on the same system.

### SUMMARY

A first exemplary embodiment of the present invention relates to a method of encrypting a data stream, including the steps of receiving the data stream, and for each data packet in the data stream, forming an encrypted packet by encrypting a header portion of the data packet while leaving a body portion of the data packet unencrypted. The method also includes the steps of assembling an encrypted data stream comprising all the encrypted packets, and outputting the encrypted data stream.

A second exemplary embodiment of the present invention relates to a method of decrypting an encrypted data stream, including the steps of receiving the encrypted data stream as input, for each data packet in the encrypted data stream, forming a decrypted packet by decrypting a header portion of the packet and determining a location of a body portion of the packet as a function of the header portion, and generating an image by decoding the decrypted packets.

A third exemplary embodiment of the present invention relates to a device for encrypting a data stream. The device includes an input arrangement configured to receive an image as input from a data source, an encoding arrangement configured to encode the image into the data stream, and an encryption arrangement configured to: for each data packet in the data stream, form an encrypted packet by encrypting a header portion of the packet while leaving a body portion of the packet unencrypted, and assemble an encrypted data stream comprising the encrypted packets.

A fourth exemplary embodiment of the present invention relates to a device for decrypting an encrypted data stream. The device includes a decryption arrangement configured to: receive the encrypted data stream as input, and for each data packet in the encrypted data stream, form a decrypted packet by decrypting a header portion of the packet and determining a location of a body portion of the packet as a function of the header portion. The device further includes a decoding arrangement configured to generate an image by decoding the decrypted packets.

A fifth exemplary embodiment of the present invention relates to a computer-readable storage medium having stored thereon a series of instructions executable by a processor, the instructions configured to cause the processor to perform the steps of: receiving an unencrypted data stream, for each data packet in the data stream, forming an encrypted packet by encrypting a header portion of the packet while leaving a body portion of the packet unencrypted, assembling an encrypted data stream comprising all the encrypted packets, and outputting the encrypted data stream.

### BRIEF DESCRIPTION OF THE DRAWINGS

FIG. 1 shows a block diagram of a system for encrypting data streams according to an example embodiment of the present invention.

FIG. 2 shows a block diagram of an input device according to an example embodiment of the present invention.

FIG. 3 shows a block diagram of an output device according to an example embodiment of the present invention.

FIG. 4 shows a set of subbands according to an example embodiment of the present invention.

FIG. 5 shows an image divided into subbands according to an example embodiment of the present invention.

FIG. 6 shows a codestream according to an example embodiment of the present invention.

FIG. 7 shows a method for encrypting data streams according to an example embodiment of the present invention.

FIG. 8 shows a method for decrypting data streams according to an example embodiment of the present invention.

### DETAILED DESCRIPTION OF EXAMPLE EMBODIMENTS

The present invention relates to methods and systems for encrypting and decrypting data streams. Exemplary embodiments of the present invention will be described with reference to encryption and decryption of JPEG2000 codestreams. A digital representation of an image may be encoded according to the JPEG2000 standard, encrypted, decrypted and decoded to generate an image which substantially represents the encoded image.

Encryption of JPEG2000 images has been recommended by the Telecommunication Standardization Sector of the International Telecommunication Union (ITU-T). In its T.807-recommendation, ITU-T suggested that JPEG2000 encoded packets should be protected by encrypting packet bodies, i.e., the data content of each data packet. After the bodies of each packet in a codestream are encrypted, a marker is applied to a main header of the codestream to enable subsequent decryption. Because of the packet-based structure of JPEG2000, header information is necessary in order to parse the codestream and move from one packet to the next. For this reason, the ITU-T recommendation does not encrypt packet headers. A disadvantage of the recommended technique is computational expense resulting from having to encrypt each packet body. However, this has been viewed as necessary, since encrypting any other portion of the codestream, e.g., packet headers, would render the codestream JPEG2000 non-compliant. That is, a JPEG2000-based decoder would not be able to parse the codestream and therefore could not decode the image. Another disadvantage is that it becomes necessary to encrypt all packet bodies. If a packet body is not encrypted, it is possible to decode it based on a corresponding packet header, even if other packet bodies in the same codestream are encrypted.

Another known encryption technique, which differs from the recommended technique discussed above, uses selective encryption of JPEG2000 encoding components (bit-planes, subbands and encoding passes) based on knowledge that different components have varying sensitivity in regards to their ability to affect image understandability. However, the known technique needs to be performed during an encoding stage. If encryption is desired after encoding, e.g., post-packetization, the packets must first be decoded, then encrypted and recompressed into new packets. Therefore, the known encryption technique can be computationally expensive.

Exemplary embodiments of the present invention will now be described which are computationally efficient without sacrificing security. Although the exemplary embodiments will be described with reference to JPEG2000 codestreams, it will be understood that the exemplary systems, devices and methods described may also be implemented with other packet-based data streams in which packet headers contain information needed to decode the packets, e.g., video and audio streams. Further, although the exemplary embodiments describe the encryption of stored images, e.g., images initially stored at an image source, alternative embodiments may involve encryption of images prior to a first instance of storage. Thus, the present invention may be adapted for use with any application in which encryption of a data stream, e.g., an image codestream, is desired.

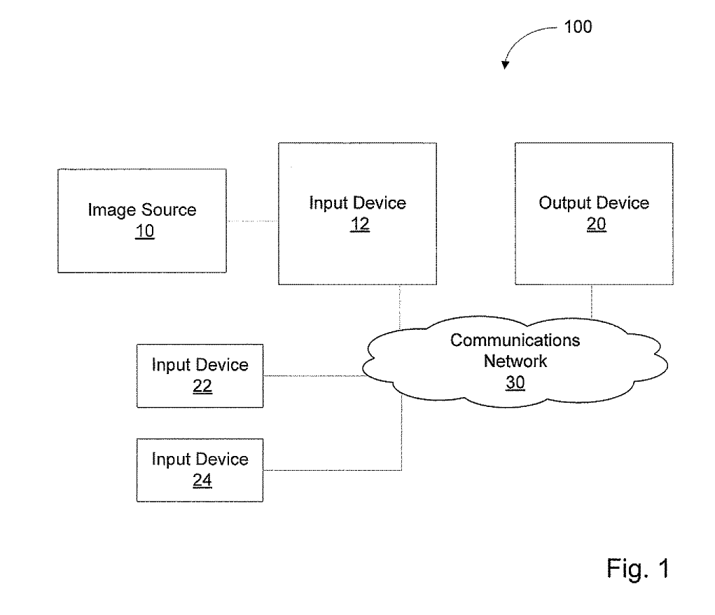

FIG. 1 shows a block diagram of a system 100 for encrypting data streams according to an example embodiment of the present invention. The system 100 may include an image source 10, one or more input devices 12, 22 and 24, an output device 20 and a communications network 30.

The image source 10 may be any electronic data source containing a digital image. The image may be a scanned image, a digital photograph, a computer generated graphic, etc. The image may be part of a collection of images, such as a slideshow, a video clip or a movie. In one embodiment, the image source 10 may be remotely located from the input devices 12, 22 and 24. The image source 10 may, for example, be an entertainment service provider such as a cable or satellite television network, a digital media delivery service, etc. Alternatively, the image source 10 may be local to one or more of the input devices 12, 22 and 24. For example, the image source 10 may be a media-encoded computer-readable medium, e.g., a floppy disk, a CD-ROM, an HD DVD, a Blu-ray disc, a flash memory drive, etc., controlled by a user of the one or more of the input devices 12, 22 and 24.

The input device 12 may be any device capable of encrypting the image and transmitting it. In the context of a home entertainment system, the input device 12 may be a set-top box, a digital cable tuner, an HD-DVD player, etc. The input device 12 may be configured to receive and encode the image, then encrypt the encoded image prior to transmitting the encrypted image to the network 30 for delivery to the output device 20. In alternative embodiments, the input device 12 may not perform encoding, but may instead receive encoded images directly from the image source.

The output device 20 may be a television, e.g., a high-definition LCD, plasma or projection television. In alternative embodiments, the output device 20 may be any other device capable of receiving and decoding the image, e.g., for immediate display, for conversion into another data format, for delivery to another device, etc.

The input devices 22 and 24 may be other input devices that communicate with the output device 20. For example, the input device 22 may be a DVD player configured to transmit images stored on a DVD to the output device 20, while the input device 24 may be a video game console configured to present an interactive game to a user at the output device 20 or another output device, e.g., another television.

The network 30 may communicatively connect the input devices 12, 22 and 24 to the output device 20. The network 30 may be any type of wired or wireless network including, for example, a virtual private network, a local area network, a wide area network, the Internet, etc. Accordingly, if the network 30 is wireless, one or more wireless transceivers, routers, or switches may be included. If the network 30 is wired, one or more wired routers, switches, or other wired hardware arrangements, e.g., direct wire connections, may be included.

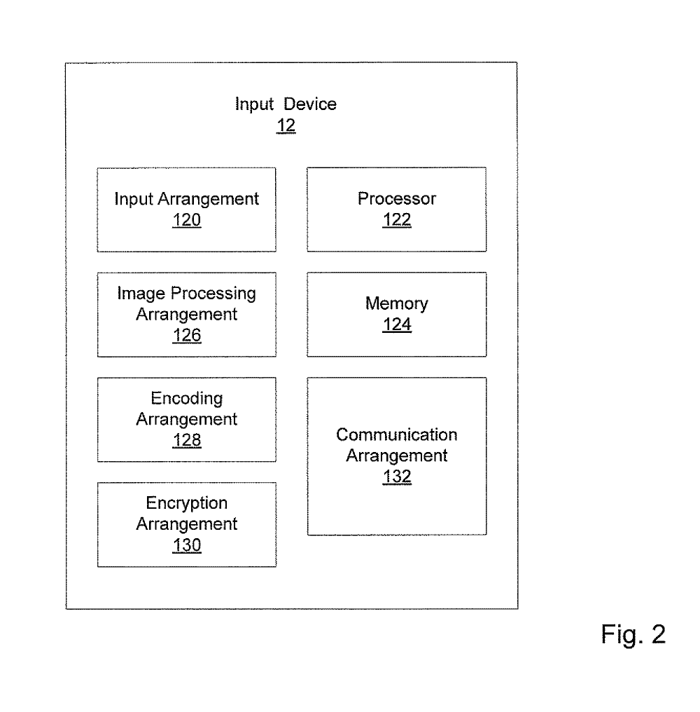

FIG. 2 shows a block diagram of the input device 12 according to an example embodiment of the present invention. The input device 12 may include an input arrangement 120, a processor 122, a memory 124, an image processing arrangement 126, an encoding arrangement 128, an encryption arrangement 130 and a communication arrangement 132. The input arrangement 120 may be configured to receive the image from the image source 10. For example, if the image source 10 is a cable provider, the input arrangement 120 may include a hardware port connected to a cable line. If the image source 10 is a computer-readable medium, the input arrangement 120 may include any hardware or software necessary for reading the image, e.g., a disc drive and corresponding software drivers.

The processor 122 may be a microprocessor, an ASIC, or any other electric circuit or combination of circuits configured to perform instructions located in the memory 320. For example, the processor 122 may be configured to perform computations in support of the operation of the image processing arrangement 126, the encoding arrangement 128 and the encrypting arrangement 130. Alternatively, each of the arrangements 126, 128 and 130 may have a dedicated processor, in which case a support role of the processor 122 may be limited, e.g., to facilitating data communication amongst the various components of the input device 12.

The memory 124 may include instructions and data. The instructions may include general operating and control routines, e.g., operating system routines. The data may comprise a temporary storage space for data used by the processor 122 or other device components, e.g., the arrangements 126, 128 and 130. For example, the data may include raw image data, encoded image data, partially encrypted codestreams, intermediate values, etc.

The processing arrangement 126 may be configured to receive the image from the input arrangement 120 and perform any necessary processing prior to encoding the image. For example, the processing arrangement 126 may be configured to divide the image into a plurality of smaller parts, e.g., tiles, and perform digital signal processing, e.g., wavelet transformation of each of the plurality of smaller parts. Output of the processing arrangement 126, e.g., a set of wavelet transform coefficients, may be delivered to the encoding arrangement 128 for subsequent encoding.

The encoding arrangement 128 may be configured to perform encoding of the wavelet transform coefficients to form an encoded image. Encoding may involve quantization, e.g., turning the wavelet transform coefficients into scalar quantities. Encoding may also involve entropy coding, e.g., image compression based on any number of compression algorithms. A compressed image may be output in the form of one or more codestreams, e.g., data streams with packets containing compressed image data.

The encryption arrangement 130 may be configured to perform encryption of the one or more codestreams according to one or more encryption methods. In one embodiment, the encryption method is an Advanced Encryption Standard (AES) algorithm, e.g., 128 bit AES encryption. In alternative embodiments, other encryption methods may be used, e.g., Data Encryption Standard (DES), other symmetric encryption algorithms such as ElGamal, or asymmetric encryption algorithms such as RSA. The encryption arrangement 130 may communicate with a decrypting device, e.g., the output device 20, via the communication arrangement 132. Communication may involve, for example, transmitting a shared key to or from the decrypting device so that the one or more codestreams can be encrypted and decrypted using the shared key. Alternatively, if an asymmetric algorithm is used, communication may involve transmitting a public key of the decrypting device to the input device 12.

The communication arrangement 132 may include any hardware and/or software arrangement configured to communicatively connect to the network 30. The communication arrangement 132 may, for example, convey the encrypted codestreams to the network 30 via a wired or a wireless connection. Accordingly, the communication arrangement 132 may include components such as a transceiver, a data bus, an input buffer and an output buffer.

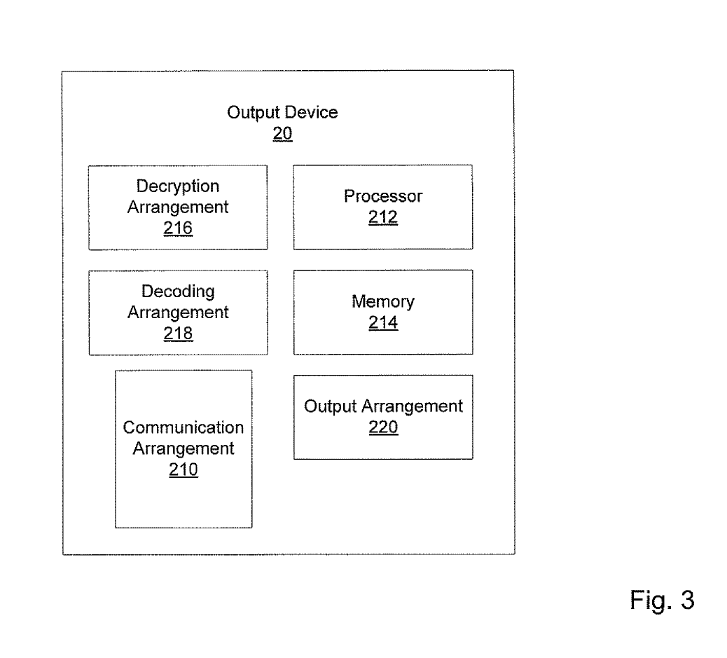

FIG. 3 shows a block diagram of the output device 20 according to an example embodiment of the present invention. The output device 20 may include a communication arrangement 210, a processor 212, a memory 214, a decryption arrangement 216, a decoding arrangement 218 and an output arrangement 220. The communication arrangement 210 may communicate with an input device via the network 30 and may include components such as a transceiver, a data bus, an input buffer and an output buffer. The communication arrangement 210 may be configured to receive the encrypted codestreams from the input device 12.

The processor 212 may be a microprocessor, an ASIC or any other electric circuit or combination of circuits configured to perform instructions located in the memory 214. For example, the processor 212 may be configured to perform computations in support of the operation of the decryption arrangement 216, the decoding arrangement 218 and the output arrangement 220. Alternatively, each of the arrangements 216, 218 and 220 may have a dedicated processor, in which case a support role of the processor 212 may be limited, e.g., to facilitating data communication amongst the various components of the output device 20.

The memory 214 may include instructions and data. The instructions may include general operating and control routines, e.g., operating system routines. The data may comprise a temporary storage space for data used by the processor 212 or other device components, e.g., the arrangements 216, 218 and 220. For example, the data may include raw image data, decoded image data, partially decrypted codestreams, intermediate values, etc.

The decryption arrangement 216 may be configured to perform decryption of the encrypted codestreams in accordance with the encryption method used by the input device 12. For example, if the encryption method is AES encryption, then the encrypted codestreams may be decrypted using a shared key. Decrypted codestreams may then be decoded by the decoding arrangement 218.

The decoding arrangement 218 may be configured to generate a reconstructed image by decoding the decrypted codestreams. The decoding arrangement 218 may determine image information based on a main codestream header, packet headers, or any other aspects of a decrypted codestream's structure or contents. Based on the image information, packets of the decrypted codestream may then be decoded to create the reconstructed image, which may be substantially similar in appearance to the original image provided by the image source 10.

The output arrangement 220 may be configured to display the reconstructed image, e.g., on a display screen. Alternatively, the output arrangement 220 may transmit the reconstructed image for further processing, e.g., to the memory 214 for later access or to another output device.

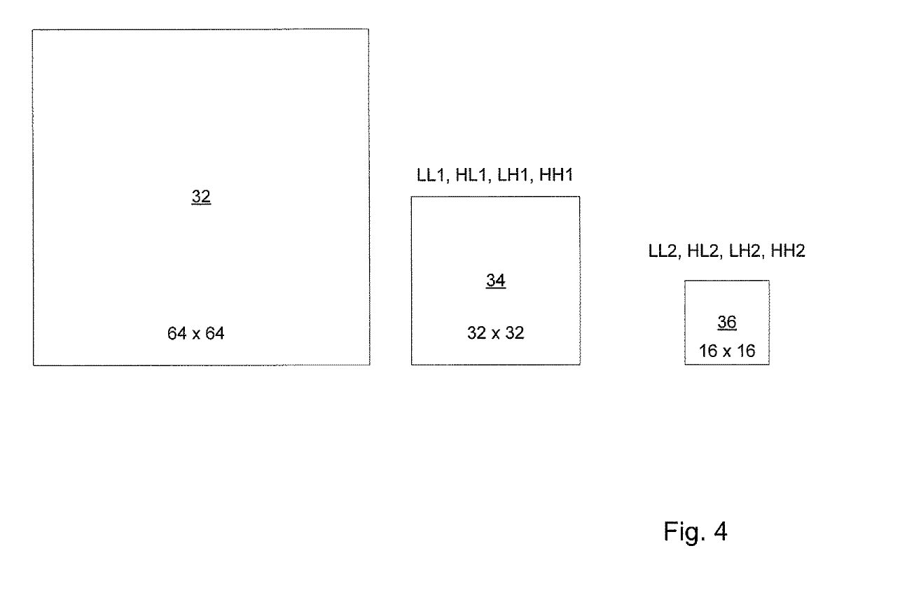

FIG. 4 shows a set of subbands generated from a wavelet transform of an image 32 according to an example embodiment of the present invention. Each successive subband represents a scaled-down version of a predecessor subband or image. For example, a length and width of each subband may be half that of its predecessor. As shown, if the image 32 is 64×64 pixels, a first set of subbands LL1, HL1, LH1 and HH1 34 may each be 32×32, and a second set of subbands LL2, HL2, LH2 and HH2 may each be 16×16. Each of the subbands LL1, HL1, LH1 and HH1 34 may include wavelet transform coefficients corresponding to a wavelet transform of the image 32 across varying frequencies along both the horizontal and vertical directions. The subband HH1 may correspond to the highest frequencies in both directions, while the subband LH1 may correspond to low horizontal and high vertical frequencies. The subband LL1 may correspond to low frequencies in both directions.

The wavelet transform may be analogized to high-pass and low-pass filters. The subbands HL1, LH1 and HH1 represent high-pass filtered versions of the image 32. The subband LL1 represents a low-pass filtered version of the image 32. The subbands HL1, LH1 and HH1 may therefore be considered as providing difference information, whereas the subband LL1 may be considered to be a scaled-down approximation of the image 32.

The second set of subbands LL2, HL2, LH2 and HH2 36 may be generated by applying a wavelet transform to a low frequency subband from the first set 34, e.g., LL1. Generation of additional subbands may be repeated any number of times by applying wavelet transformation to the lowest frequency subband. Returning to the filter analogy, the subbands HL2, LH2 and HH2 may represent high-pass filtered versions of LL1 and the subband LL2 may represent a low-pass filtered version of LL1. The wavelet transforms may be summarized as generating a single scaled-down approximation image, e.g., LL2, along with a series of scaled-down difference images, e.g., HL2, LH2, HH2, HL1, LH1 and HH1.

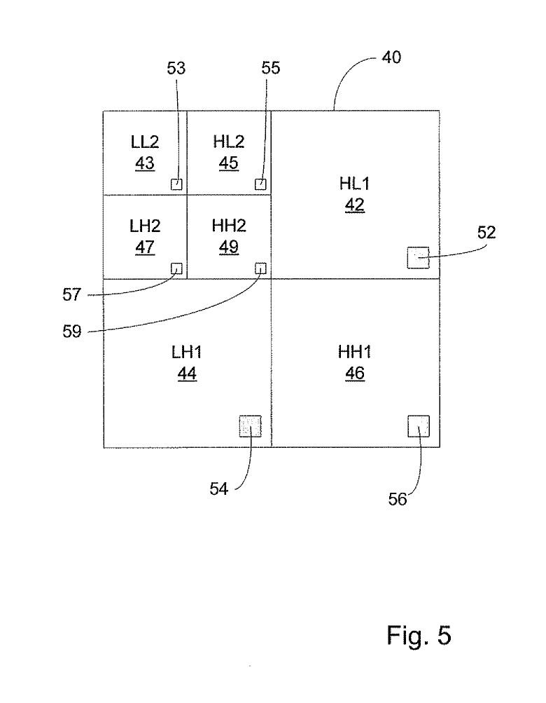

FIG. 5 shows an image 40 divided into subbands according to an example embodiment of the present invention. A first wavelet transform may divide the image 40 into subbands LL1 (not shown), HL1 42, LH1 44 and HH1 46. A second wavelet transform may divide the subband LL1 into subbands LL2 43, HL2 45, LH2 47 and HH2 49. Each subband may be divided into precincts. For example, a precinct 52 of HL1 42, a precinct 54 of LH1 44 and a precinct 56 of HH1 46 may each correspond to the same location within the image 40. Similarly, a precinct 53 of LL2 43, a precinct 55 of HL2 45, a precinct 57 of LH2 47 and a precinct 59 of HH2 49 may each correspond to a second location of the image 40.

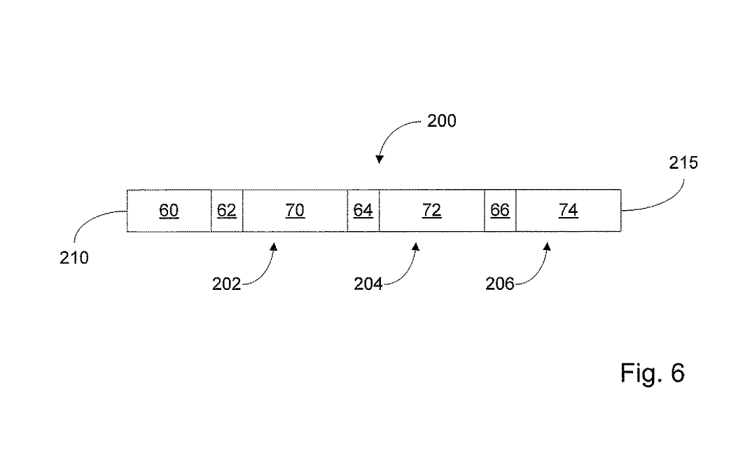

FIG. 6 shows a codestream 200 according to an example embodiment of the present invention. The codestream 200 may include a main header 60 located at a head portion 210 thereof and one or more packets 202, 204 and 206 forming a remainder, including a tail portion 215 thereof. Each packet may have a header and a body. For example, the packets 202, 204 and 206 may have respective headers 62, 64 and 66, and respective bodies 70, 72 and 74. The packets 202, 204 and 206 may each contain information corresponding to one or more precincts, which may be divided into code blocks. Referring back to FIG. 5, the packet 202 may include information from the precinct 53, the packet 204 may include information from the precincts 55, 57 and 59, and the packet 206 may include information from the precincts 52, 54 and 56. Thus, only the packet 202 may contain LL subband information.

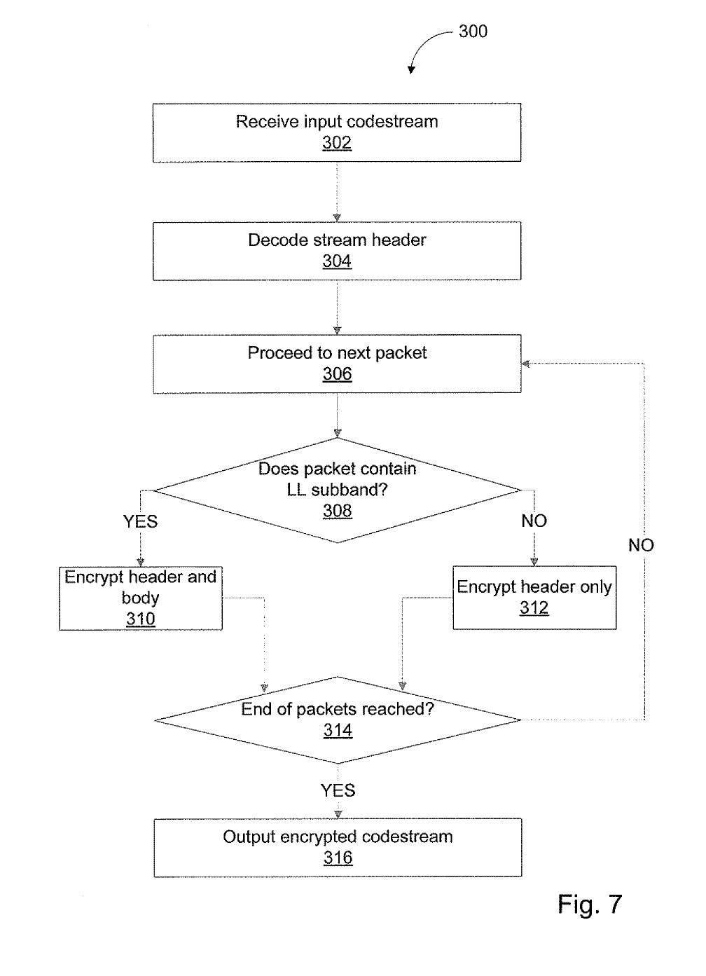

FIG. 7 shows a method 300 according to an example embodiment of the present invention. The method 300 may be performed at any encrypting device according to the present invention, e.g., the input device 12, and may be implemented in any combination of hardware and/or software. In 302, an input codestream may be received, e.g., at the input device 12, from the image source 10.

In 304, a main header of the input codestream may be decoded to produce information corresponding to the entire image, e.g., the image 40. The main header information may include, e.g., image size and tile size.

In 306, the method 200 proceeds to the next packet, e.g., the first packet after the main header. A header of the packet may be read to obtain packet information.

In 308, it may be determined whether the packet contains LL subband information. The determination may be based on the packet information from the packet header.

If the packet contains LL subband information, both the header and the body are encrypted in 310 to form an encrypted packet, e.g., using 128-bit AES encryption. Although encryption of the body may not be needed, it may be desirable to encrypt the body as an additional security measure. However, because encrypting every packet body is computationally expensive, body encryption may be limited to those parts of the codestream which contain the most significant information, e.g., LL subband packets such as those corresponding to the subband LL2 43, since these packets correspond to approximation images.

If the packet does not contain LL subband information, only the header may be encrypted in 312 to form an encrypted packet. Encryption may be performed using a single key for the entire codestream. Alternatively, different keys may be used to encrypt the packet headers, e.g., switching to a new key every ten packets.

In 314, it may be determined whether an end of the packets is reached. If the end is not reached, the method 300 returns to 306 and proceeds to the next packet. If the end is reached, the method 300 proceeds to 316.

In 316, the encrypted packets may be output as an encrypted codestream. For example, the encrypted packets may be appended to the main header of the input codestream to form the encrypted codestream.

Although the method 300 may be applied to fully encoded codestreams, it will be appreciated that the method 300 may also be adapted to encrypt codestreams prior to packetization. For example, encryption may occur during encoding rather than after the codestream has been encoded.

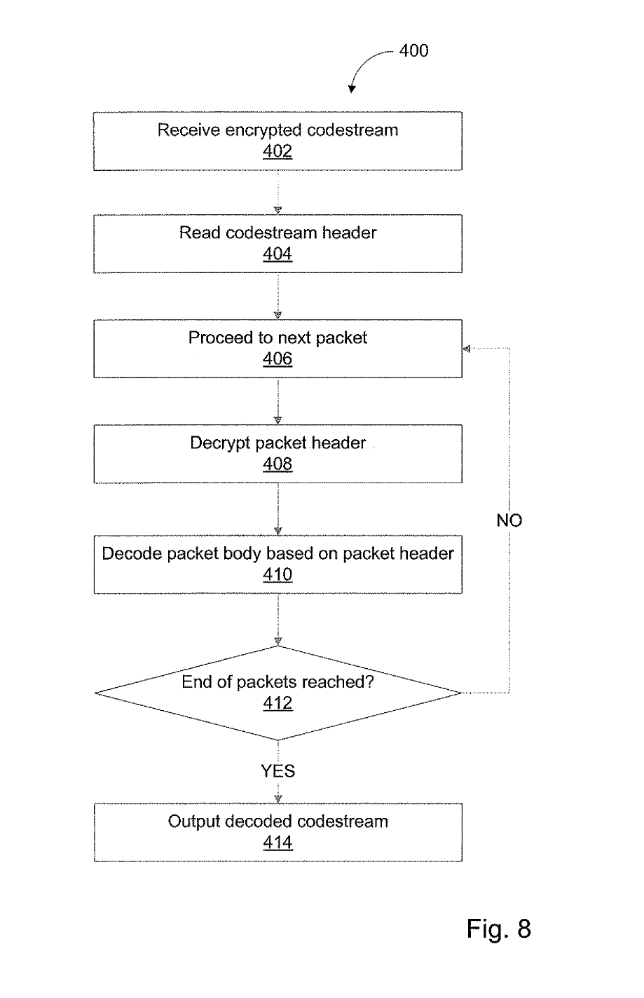

FIG. 8 shows a method 400 according to an example embodiment of the present invention. The method 400 may be performed at any decrypting device according to the present invention, e.g., the output device 20, and may be implemented in any combination of hardware and/or software. The method 400 may be utilized in conjunction with the method 300 to perform an encryption and a corresponding decryption of an input codestream. In 402, an encrypted codestream may be received, e.g., at the output device 20, from the input device 12.

In 404, a main header of the encrypted codestream may be read. Based on information in the main header, the method 400 proceeds to the next packet in 406, e.g., a packet immediately following the header.

In 408, a packet header may be located and decrypted, e.g., using a shared key.

In 410, a packet body may be decoded based on the decrypted packet header. If the decrypted packet header indicates that the packet includes LL subband information, then the packet body may be decrypted prior to decoding. However, if the decrypted packet header does not include LL subband information, then the packet body may be decoded directly.

In 412, it may be determined whether an end of the packets has been reached. If the end is not reached, then the method 400 returns to 406 and proceeds to the next packet. If the end is reached, then the method 400 proceeds to 414.

In 414, a decoded codestream may be output, e.g., combined with other decoded codestreams to form a complete image for display. The decoded codestream may be formed by, for example, combining the decoded packet bodies into a new codestream.

Although the exemplary embodiments described involve encryption of all packet headers, it will be appreciated that encryption of all headers need not occur. Encryption of any packet header may be sufficient to render any portion of the codestream which follows the encrypted header non-parseable. Without decrypting the encrypted header, it may not be possible to determine where the next header is located, and therefore it may not matter that the next header is non-encrypted. Accordingly, in alternative embodiments, it may be possible that some packet headers are not encrypted.

In the preceding specification, the present invention has been described with reference to specific example embodiments thereof. It will, however, be evident that various modifications and changes may be made thereunto without departing from the broader spirit and scope of the present invention as set forth in the claims that follow. The embodiments described herein may be presented combined with each other in various combinations. The specification and drawings are accordingly to be regarded in an illustrative rather than restrictive sense.

What is claimed is:

1. A method of encrypting a data stream, comprising:
receiving the data stream;
for each data packet in the data stream, forming an encrypted packet by encrypting a header portion of the data packet while leaving a body portion of the data packet unencrypted;
assembling an encrypted data stream comprising all the encrypted packets; and
outputting the encrypted data stream.

2. The method of claim 1, wherein the data stream is a JPEG2000 codestream.

3. The method of claim 2, further comprising:
determining that the data packet contains data corresponding to an LL subband; and
responsive to the determination, encrypting the body portion of the data packet.

4. The method of claim 1, wherein the data stream is received from an image encoder.

5. The method of claim 1, wherein the encrypting is performed using an Advanced Encryption Standard (AES) encryption algorithm.

6. The method of claim 1, wherein the header portion must be decoded in order to read the body portion of the data packet.

7. A method of decrypting an encrypted data stream, comprising:
receiving the encrypted data stream as input;
for each data packet in the encrypted data stream, forming a decrypted packet by decrypting a header portion of the packet and determining a location of a body portion of the packet as a function of the header portion; and
generating an image by decoding the decrypted packets.

8. The method of claim 7, wherein the data stream is a JPEG2000 codestream.

9. The method of claim 8, further comprising:
determining that the data packet contains data corresponding to an LL subband; and
responsive to the determination, decrypting the body portion of the packet prior to forming the decrypted packet.

10. The method of claim 7, wherein the encrypting is performed using an Advanced Encryption Standard (AES) encryption algorithm.

11. The method of claim 7, wherein the header portion must be decoded in order to read the body portion of the data packet.

12. A device for encrypting a data stream comprising:
an input arrangement configured to receive an image as input from a data source;
an encoding arrangement configured to encode the image into the data stream; and
an encryption arrangement configured to:
for each data packet in the data stream, form an encrypted packet by encrypting a header portion of the packet while leaving a body portion of the packet unencrypted, and
assemble an encrypted data stream comprising the encrypted packets.

13. The device of claim 12, wherein the data stream is a JPEG2000 codestream.

14. The device of claim 13, wherein the encryption arrangement is configured to:
determine that the data packet contains data corresponding to an LL subband; and
responsive to the determination, encrypt the body portion of the packet.

15. The device of claim 12, wherein the data stream is received from an image encoder.

16. The device of claim 12, wherein the encrypting is performed using an Advanced Encryption Standard (AES) encryption algorithm.

17. The device of claim 12, wherein the header portion must be decoded in order to read the body portion of the data packet.

18. A device for decrypting an encrypted data stream, comprising:
a decryption arrangement configured to:
receive the encrypted data stream as input, and
for each data packet in the encrypted data stream, form a decrypted packet by decrypting a header portion of the packet and determining a location of a body portion of the packet as a function of the header portion; and
a decoding arrangement configured to generate an image by decoding the decrypted packets.

19. The device of claim 18, wherein the data stream is a JPEG2000 codestream.

20. The device of claim 19, wherein the decryption arrangement is configured to:
determine that the data packet contains data corresponding to an LL subband; and
responsive to the determination, decrypt the body portion of the packet prior to forming the decrypted packet.

21. The device of claim 18, wherein the encrypting is performed using an Advanced Encryption Standard (AES) encryption algorithm.

22. The device of claim 18, wherein the header portion must be decoded in order to read the body portion of the data packet.

23. A computer-readable storage medium having stored thereon a series of instructions executable by a processor, the instructions configured to cause the processor to perform the steps of:
receiving an unencrypted data stream;
for each data packet in the data stream, forming an encrypted packet by encrypting a header portion of the packet while leaving a body portion of the packet unencrypted;
assembling an encrypted data stream comprising all the encrypted packets; and
outputting the encrypted data stream.
